(19) United States
(12) Patent Application Publication
(10) Pub. No.: US 2016/0371608 A1
(43) Pub. Date: Dec. 22, 2016

(54) PARKING LOT RESERVATION METHOD AND SYSTEM THEREFOR

(71) Applicant: MODU COMPANY INC., Seoul (KR)

(72) Inventor: Soonam KAHNG, Seongnam, Gyeonggi-do (KR)

(21) Appl. No.: 15/101,315

(22) PCT Filed: Nov. 18, 2014
(86) PCT No.: PCT/KR2014/011068

§ 371 Date: Jun. 2, 2016

(30) Foreign Application Priority Data
Dec. 2, 2013 (KR) 10-2013-0148801

(51) Int. Cl. G06Q 10/02; G08G 1/14

(52) U.S. Cl. CPC G06Q 10/02; G08G 1/146; G08G 1/144

(57) ABSTRACT

The present invention relates to a parking lot reservation method and a system therefor. The present invention is performed by a parking lot reservation server and comprises the steps of: receiving a parking lot information request from a subscriber terminal; providing one or more pieces of parking lot information to the subscriber terminal in response to the parking lot information request; performing a reservation procedure by receiving parking lot information of a parking lot selected by the reservation terminal among the one or more parking lots and a parking lot reservation request of the subscriber terminal; and obtaining location information of the subscriber terminal before pre-configured time from the reservation time when a parking lot reservation is completed, to provide the location information to an operator terminal of a reserved parking lot.

### TECHNICAL FIELD

The present invention relates to a parking lot reservation method and a system therefor, and in particular to a parking lot reservation method and a system therefor wherein a parking lot operator is able to recognize an estimate time of arrival of a parking lot subscriber in such a way to provide a position information of the parking lot subscriber to the parking lot operator.

### BACKGROUND ART

A typical parking lot management system is configured in such a way that a plurality of parking spaces can be managed using cameras and vehicle number recognition devices, by which a vehicle entry and exit can be efficiently managed, and a parking fee can be automatically paid.

In the aforementioned conventional parking lot management system, it, however, is impossible to know in a remote area if there is any space available for parking in a parking lot which is located at a predetermined region or how many available spaces there are.

The Korean patent laid-open No. 10-2012-0039229, which is a prior art technical document, describes a parking management system and a parking management method thereof, wherein a vehicle entry and exit can be accurately recognized at a parking lot equipped with a plurality of parking spaces, and the current states of parking spaces can be monitored in real time with the aid of cameras, whereby outdoor or indoor parking lots can be more efficiently managed.

The aforementioned prior art technology has a problem in the way that a parking convenience is not good since it is impossible to make a reservation for a parking space to park. More specifically, if it needs to move to another region after quickly parking or it needs to park only at a specific parking lot, a parking-related convenience is very bad since it is impossible to make a reservation for a parking space.

Moreover, a parking lot, in general, is designed to make profit based on the hours of use of each parking space. If an idle parking space increases, the profit may go bad. According to a conventional reservation method, if a subscriber does not show up at a reserved time after having made a reservation for a parking space or comes late, the operator of a parking lot may suffer damage.

For this reason, from the view of the operator of a parking lot, it requires to develop a new method which is able to minimize the occurrence of idle parking spaces by previously confirming an actual arrival time of a subscriber or a subscriber's intention, while providing to make a reservation for a predetermined parking space for the sake of efficient uses of all the parking spaces.

### DISCLOSURE OF INVENTION

Accordingly, it is an object of the present invention to provide a parking lot reservation method and a system therefor, which make it possible for an operator of a parking lot to efficiently manage parking spaces in such a way that a parking lot operator is able to recognize an estimate time of arrival of a parking lot subscriber by providing a position information of the parking lot subscriber to the parking lot operator.

It is another object of the present invention to provide a parking lot reservation method and a system therefor, wherein a parking space reservation may be changed or a parking space reservation may be cancelled in case of any situation of a subscriber who has made a reservation for a predetermined parking space.

It is yet another object of the present invention to provide a parking lot reservation method and a system therefor, wherein if an idle parking space of a predetermined parking lot lacks after a parking space subscriber has requested a parking space reservation, the subscriber may be guided to go another nearby parking lot, whereby parking space subscribers can be guided to another nearby parking lot.

To achieve the above objects, according to a first aspect of the present invention, there is provided a parking lot reservation method, which may include, but is not limited to, a step wherein a parking lot reservation is carried out by a parking lot reservation server, and a parking lot information request is received from a subscriber terminal; a step wherein at least one parking lot information is provided to the subscriber terminal in response to the parking lot information request; a step wherein a reservation procedure is carried out by receiving a parking lot information of a parking lot which is selected by the subscriber terminal from at least one parking lots and a parking lot reservation request of the subscriber terminal; and a step wherein when a parking lot reservation is completed, a position information of the subscriber terminal is obtained before a previously set time from a reservation-made time, and is provided to an operator terminal of the reserved parking lot.

To achieve the above objects, according to a second aspect of the present invention, there is provided a parking lot reservation system which may include, but is not limited to a request receiving unit which is configured to receive a parking lot information request from a subscriber terminal in a parking lot reservation server; a parking lot information providing unit which is configured to provide at least one parking lot information to the subscriber terminal in response to the parking lot information request; a reservation processing unit which is configured to carry out a reservation procedure by receiving a parking lot information of the parking lot selected by the subscriber terminal among at least one parking lots, and a parking lot reservation request of the subscriber terminal; and a position information providing unit which is configured to obtain a position information of the subscriber terminal before a previously set time from the reserved time if the parking lot reservation is completed, and provide the obtained information to the operator terminal of the reserved parking lot.

### Advantageous Effects of the Invention

According to an embodiment of the present invention, a parking lot operator is able to complete a parking space reservation based on the current statuses of parking spaces or change or cancel any parking space reservations since the parking lot operator is able to recognize an estimate time of arrival of a predetermined subscriber who has made a reservation for a parking space by providing a position information of a parking space subscriber to the parking lot operator.

According to another embodiment of the present invention, if there is not any empty parking space in a parking lot after a parking space subscriber requests a reservation for a parking space, the parking space subscriber may receive a reservation cancellation notice from the parking lot operator, so it is possible to recognize the current statuses of parking spaces of a parking lot before the parking space subscriber comes to the parking lot, which may make it possible to efficiently save parking time.

According to yet another embodiment of the present invention, if a lot of parking space reservation requests concentrate at a parking lot, the information on another nearby parking lot can be provided to the subscribers, so the parking space subscribers can be guided to another nearby parking lot.

### BRIEF DESCRIPTION OF DRAWINGS

FIG. 1 is a view schematically illustrating a configuration of a parking lot reservation system according to an embodiment of the present invention.

FIG. 2 is a functional block diagram illustrating a parking space reservation server of a parking lot reservation system according to an embodiment of the present invention.

FIG. 3 is a flow chart for describing a parking lot reservation method according to an embodiment of the present invention.

FIG. 4 is a flow chart for describing a state wherein an estimate time of arrival calculated based on a position information of a subscriber terminal and a position information of a reserved parking lot exceeds a remaining time which is calculated based on a parking space reservation time and the current time.

### MODES FOR CARRYING OUT THE INVENTION

The embodiments of the present invention will be described with reference to the accompanying drawings to the extent that a person having ordinary skill in the art can easily implement. The present invention may be implemented in various forms, and it is not limited to the embodiments which will be disclosed. It is noted that the portions which are not directly related with the descriptions of the present invention, will be omitted for the sake of clarified descriptions of the present invention, and any similar portions found throughout the specification will be given similar reference numbers.

Throughout the specification, the description of “a predetermined portion is ‘connected’ with another portion” represents “a direct connection” as well as “an electrical connection” with a predetermined component interposed between two components. Moreover, unless otherwise stated herein, the description of “a predetermined component comprises another component” represents that it may further include other components, not excluding such components. The present invention will be described in detail with reference to the accompanying drawings.

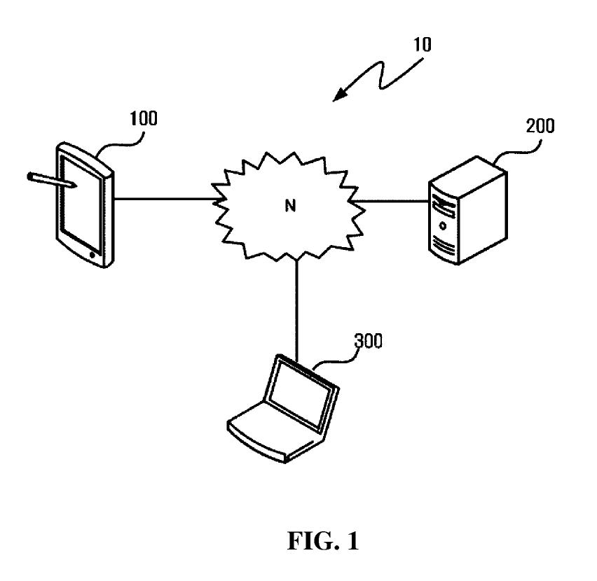

FIG. 1 is a view schematically illustrating a configuration of a parking lot reservation system according to an embodiment of the present invention.

The present invention will be described in detail with reference to the accompanying drawings.

FIG. 1 is a view illustrating a configuration of a parking lot reservation system according to an embodiment of the present invention.

As illustrated in FIG. 1, the parking lot reservation system 10 according to an embodiment of the present invention may include, but is not limited to, a subscriber terminal 100 connected via a network (N), a parking lot reservation server 200, and an operator terminal 300.

The network (N) may be implemented using a Local Area Network (LAN), Wide Area Network (WAN), Value Added Network (VAN), Personal Area Network (PAN), a mobile radio communication network or all kinds of wired or wireless networks, for example, a satellite communication network.

It is preferred that the subscriber terminal 100 may be a portable terminal which has a function to collect the position of a subscriber in a state where a position collection unit equipped with a GPS (Global Positioning System) is installed.

The portable terminal is, for example, a wireless communication device which may provide a portability and a mobility. It may include all kinds of handheld type wireless communication devices, for example, PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminal, Smart Phone, etc.

The aforementioned subscriber terminal 100 may be used to make a parking lot visit reservation on a webpage provided by a parking lot reservation server 200 or make a parking lot visit reservation by installing a parking application which is configured to operate in cooperation with the parking lot reservation server 200.

Moreover, the subscriber terminal 100 may be configured to receive a parking lot information of a parking lot based on a parking lot reservation service which is provided by the parking lot reservation server 200.

Meanwhile, the parking lot reservation server 200 is an information processing device which is connected via a network (N) to the subscriber terminal 100 and the operator terminal 300, thus receiving and transmitting data, and is configured to provide a parking lot reservation service to the subscriber terminal 100 and the operator terminal 300.

When the parking lot reservation server 200 receives a parking space information request from the subscriber terminal 100, it may collect a position information of the subscriber and provide a parking space information which corresponds to the position information of the subscriber. Moreover, when the parking lot reservation server 200 receives a parking space reservation request from the subscriber terminal 100, it may carry out a reservation procedure with respect to the parking space selected by the subscriber.

Meanwhile, the operator terminal 300 may be an electronic terminal which may be connectable via a network (N) to the parking lot reservation server 200 or be connectable to the subscriber terminal 100 and the parking lot reservation server 200.

The aforementioned operator terminal 300 may be configured to receive a position information of the subscriber terminal 100 from the parking lot reservation server 200, thus estimating in advance the estimate time of parking space arrival of the subscriber terminal 100.

The configuration of the parking lot reservation server 200 will be described in detail.

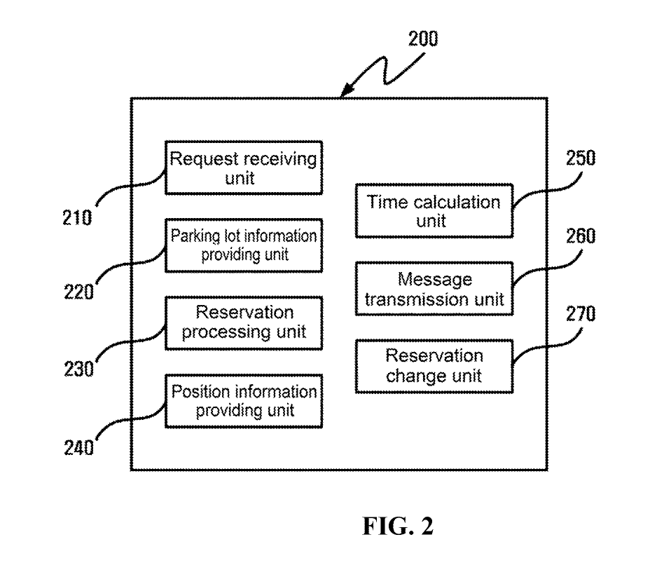

FIG. 2 is a functional block diagram illustrating a parking space reservation server of a parking lot reservation system according to an embodiment of the present invention.

As illustrated in FIG. 2, the parking lot reservation server 200 may include a request receiving unit 210. The request receiving unit 210 is employed to receive a parking space information request from the subscriber terminal 100. Here, the parking space information request from the subscriber terminal 100 may include an information on the current position of the subscriber terminal 100 or on the position selected or searched by the subscriber terminal 100.

Meanwhile, the parking lot reservation server 200 may include a parking lot information providing unit 220. In response to the parking space information request, the parking lot information providing unit 220 may provide at least one parking lot information to the subscriber terminal 100. The parking lot information may include at least one among a parking lot location, a parking lot name, a parking lot address, a parking lot telephone number, and a parking lot homepage.

The parking lot information may be at least one parking lot information which has been previously stored at and provided from a database (not illustrated) of the parking lot reservation server 200 or may be at least one parking information which has been registered at and provided from a third party server which is configured to operate in cooperation with the parking lot reservation server 200.

Meanwhile, the parking lot information providing unit 220 may be configured to receive a parking space reservation cancellation request from the operator terminal 300, which will be described later, and provide to the subscriber terminal 100, which belongs to a parking space reservation cancellation subscriber, a parking lot information of at least another parking lot neat the corresponding parking lot if there is not any idle parking space at the parking lot where the aforementioned reservation has been made through the subscriber terminal 100.

If the parking lot information providing unit 220 receives a parking space reservation cancellation request from the operator terminal 300, it may receive one or more parking lot information which has been previously stored in the database or one or more parking lot information from the third party server and may provide to the subscriber terminal 100 which belongs to the reservation cancellation subscriber.

The parking lot information providing unit 220 may provide a parking lot information by selecting another parking lot which is located near the parking lot which has been reserved or is to be reserved via the subscriber terminal 100. In this way, it is possible to prevent the parking lot reservations from concentrating at one parking lot, and enough parking spaces may be made, thus providing the subscribers with optimum parking lot services.

The parking lot reservation server 200 may include a reservation processing unit 230.

The reservation processing unit 230 may carry out a reserving procedure in such a way to receive a parking lot information of the parking lot selected via the subscriber terminal 100 among at least one parking lot provided by the parking lot information providing unit 220 and receive a parking lot reservation request of the subscriber terminal 100.

The parking lot reservation request may include a parking lot reservation information. The parking lot reservation information may include any of a subscriber name, a contact information, a parking lot name, a parking lot visiting time (a reservation time), and a parking lot use hour (a stay hour).

In a state where the number of idle parking spaces of each parking lot have been recognized, the reservation processing unit 230 may process at its side a parking lot reservation request received from the subscriber terminal 100 or may finally determine the reservation for a corresponding parking space only if the operator terminal 300 agrees such a reservation after having transmitting, to the operator terminal 300 of a corresponding parking lot, a parking lot reservation request received from the subscriber terminal 100.

The parking lot reservation server 200 may include a position information providing unit 240.

The position information providing unit 240 may obtain the position information of the subscriber terminal 100 from a reservation-made time to a previously set time if the parking lot reservation has been completed and may provide it to the operator terminal 300 of the reserved parking lot.

For example, if the reservation-made time is 2 p.m., and a previously set time is one hour before the reservation-made time, the position information providing unit 240 may obtain the position information of the subscriber terminal 100 at 1 p.m.

The position information providing unit 240 is able to obtain a position information of the subscriber terminal 100 in such a way to use at least one among a GPS information of the subscriber terminal 100, an identification information of a network equipment searched from the subscriber terminal 100, and a mobile IP (Internet Protocol) address information of the subscriber terminal 100.

Moreover, the position information providing unit 240 may provide the thusly obtained position information to the operator terminal 300 of the reserved parking lot.

Furthermore, the position information providing unit 240 may transmit a push message to obtain a position information of the subscriber terminal 100 if a time passes before as much as the previously set time from the reservation-made time. The position information providing unit 240, therefore, may obtain a position information which is calculated since the subscriber terminal 100 receives and confirms the push message and in response thereto executes a parking application, and subsequently may provide it to the operator terminal 300.

For example, the subscriber terminal 100 may be equipped with an application which is programmed to transmit a position information to the operator terminal 300 if it receives a push message from the position information providing unit 240. If the application installed at the subscriber terminal 100 receives the push message, the position information of the subscriber terminal 100 may be transmitted to the operator terminal 300.

The push message may be transmitted, repeatedly, a couple of times, to the subscriber terminal at a previously set time interval before the reserved time. For example, if the reserved time is 2 p.m., and it is programmed that the push message is sent at every 15 minutes interval from one hour before the reserved time, the push message may be sent repeatedly at 1 p.m., 1:15 p.m., 1:30 p.m., and 1:45 p.m.

The push message may include an information on a reserved parking lot, a reserved time, etc.

The position information providing unit 240 may be configured to continuously obtain for a predetermined time the position of the subscriber terminal 100, and provide a movement trajectory of a corresponding subscriber.

The parking lot information providing unit 220 may be configured to receive a predetermined information, which includes a destination information and a meeting time information of the subscriber terminal 100, from the subscriber terminal 100 or a predetermined management server (not illustrated) in cooperation with the subscriber terminal 100, while the position information providing unit 240 is providing the position information of the subscriber terminal 100 to the operator terminal 300, and subsequently the parking lot information providing unit 220 may provide the received information to the operator terminal 300 of the parking lot reserved by the subscriber.

For example, if the destination of the subscriber terminal 100 is “Samsung-dong KOEX”, and the meeting time is from 2 p.m. to 4 p.m., the parking lot information providing unit 220 may be configured to provide to the subscriber terminal 100 the parking lot information of the parking lot the parking spaces of which are empty from 2 p.m. to 4 p.m. among the nearby parking lots located near Samsung-dong KOEX and the parking lots which may be available for low parking fee, thus guiding the parking lot reservations to nearby parking lots. If the reservation is completed, the related schedule information of the subscriber may be provided to the operator terminal 300 of the reserved parking lot, by means of which it is possible to confirm the subscriber's intention and will on if the subscriber will actually visit the parking lot at a reserved time.

The subscriber may input in person the aforementioned predetermined information via the subscriber terminal 100. In this case, the subscriber may input using a parking application or a third party application, for example, a schedule management application. For this operation, the parking lot information providing unit 200 may directly collect the schedule information from the subscriber terminal 100 or the third party server which operates in cooperation with the third party application.

The parking lot reservation server 200 may include a time calculation unit 250.

The time calculation unit 250 is able to calculate an estimate lead time until the subscriber arrives at the parking lot based on the collected position information of the subscriber terminal 100 and the position information of the reserved parking lot. Moreover, the time calculation unit 250 may calculate an estimate time of parking lot arrival of the subscriber terminal 100 based on the estimate lead time and may provide it to the operator terminal 300 of the selected parking lot.

For example, if the position of the subscriber terminal 100 is Shinrim-dong, and the position of the reserved parking lot is Samsung-dong, the estimate lead time may be calculated based on the distance between Shinrim-dong and Samsung-dong. If the current time is 1 p.m., and the estimate lead time is 40 minutes after calculation, the estimate time of arrival may be 1:40 p.m. The time calculation unit 250 may notify, to the operator terminal 300 of the selected parking lot, that the estimate time of parking lot arrival of the subscriber terminal 100 may be 1:40 p.m.

Moreover, the time calculation unit 250 may calculate an estimate lead time based on at least one among an estimate traffic information between the subscriber terminal 100 and the parking lot, a real time traffic information, and an incident information (an accident information, a construction-related information) when calculating an estimate lead time, in addition to the position information of the subscriber terminal 100, and the position information of the reserved parking lot, namely, a distance information between the subscriber terminal 100 and the parking lot.

The parking lot reservation server 200 may include a message transmission unit 260.

The message transmission unit 260 may calculate the remaining time based on the reserved time and the current time. If the estimate lead time calculated by the time calculation unit 250 exceeds the remaining time, the message transmission unit 260 may transmit to the subscriber terminal 100 a confirmation message to ask for a parking lot reservation cancellation state or any change to a reserved time or a re-reservation, etc. The confirmation message may be transmitted in the form of a push notification.

For example, if the reserved time is 2 p.m., the current time is 1:30 p.m., the calculated remaining time is 30 minutes. If the estimate lead time calculated by the time calculation unit 250 is 40 minutes, the estimate lead time may exceed the remaining time by 10 minutes. In this case, the message transmission unit 260 may transmit to the subscriber terminal 100 a confirmation message to ask a parking lot reservation cancellation or any change to the reserved time.

In the same way, the message transmission unit 260 may transmit to the operator terminal 300 of the reserved parking lot a confirmation message to ask for a parking lot reservation cancellation if the estimate lead time calculated by the time calculation unit 250 exceeds the remaining time. In this case, the operator terminal 300 may be configured to cancel the reservation by judging that the subscriber terminal 100 is not likely to arrive at the parking lot at the reserved time, thus efficiently managing the parking lot by preventing any idle parking spaces.

The message transmission unit 260 may transmit to the subscriber terminal 100 an alarm message to guide to another nearby parking lot if the remaining time is larger than the estimate lead time, but a difference between them is within a predetermined range.

The parking lot reservation server 200 may include a reservation change unit 270.

The reservation change unit 270 may carry out a parking lot reservation cancellation in response to a reservation cancellation request if it receives a parking lot reservation cancellation request from the subscriber terminal 100 or the operator terminal 300.

Moreover, the reservation change unit 270 may transmit a message to ask any change to the reserved time of the parking lot, to the subscriber terminal 100 which is a reservation cancellation target, and when a reserved time change request is received from the subscriber terminal 100 in response thereto, a new reservation procedure for a change to a reservation time can be carried out. At this time, the old reservation can be cancelled. For example, if the old reserved time of the parking lot of the subscriber terminal 100 which is the reservation cancellation target, was 2 p.m., the reservation change unit 270 may ask if the reservation time of the parking lot will be changed to 3 p.m.

As described above, the estimate lead time may be calculated by the time calculation unit 250, and alternatively, the subscriber terminal 100 may directly calculate the estimate lead time based on the position information of the subscriber terminal 100 and the position information of the parking lot. More specifically, as described earlier, the subscriber terminal 100 is able to collect a position information of the subscriber with the aid of a subscriber's position collection function which is available by a position collection unit including a GPS module.

The subscriber terminal 100 is able to calculate an estimate lead time based on the position information of the subscriber terminal 100 and the position information of the parking lot selected by the subscriber terminal 100, and is able to calculate an estimate time of parking lot arrival based on the calculated estimate lead time.

The subscriber terminal 100 may transfer to the parking lot reservation server 200 the estimate lead time or the estimate time of arrival which have been calculated by the subscriber terminal 100. The parking lot reservation server 200 may transmit again to the operator terminal 300 the estimate lead time or the estimate time of arrival which have been received from the subscriber terminal 100.

As described above, the estimate lead time can be calculated by the time calculation unit 250 or the subscriber terminal 100, but the operator terminal 300 may directly calculate the estimate lead time in such a way to receive the position information of the subscriber terminal 100 from the parking lot reservation server 200 and use the received position information.

The operator terminal 300 may receive the position information of the subscriber terminal 100 from the parking lot reservation server 200 and then calculate an estimate lead time based on the position information of the subscriber terminal 100 and the position information of the parking lot selected by the subscriber terminal 100, and subsequently may calculate an estimate time of parking lot arrival of the subscriber terminal 100 based on the calculated estimate lead time.

The method for a parking lot reservation according to an embodiment of the present invention will be described.

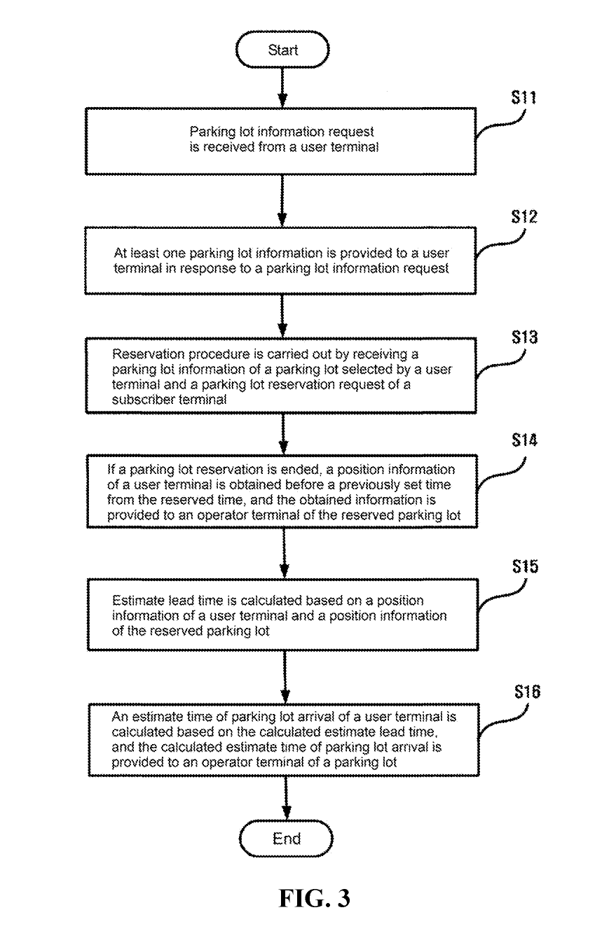

FIG. 3 is a flow chart for describing a method for a parking lot reservation according to an embodiment of the present invention.

In the parking lot reservation server 200, if a parking lot information is received from a subscriber terminal 100 (S11), at least one parking lot information can be provided to the subscriber terminal 100 in response to the parking lot information request (S120).

The parking lot information may include at least one among a parking lot name, a parking lot address, a parking lot telephone number, and a parking lot homepage address.

The aforementioned parking lot information may be one or more parking lot information which has been previously stored in a database (not illustrated) of the parking lot reservation server 200 and is provided or one or more parking lot information which has been registered in a third party which operates in cooperation with the parking lot reservation server 200 and is provided.

If a parking lot reservation cancellation request is received from the operator terminal 300, the parking lot reservation server 200 may provide to the subscriber terminal 100, which is a parking lot reservation cancellation target, a parking lot information of at least one or more parking lots located near the reserved parking lot.

This case is configured so that the operator terminal 300 can request a reservation cancellation if the reservation for the parking lot selected by the subscriber terminal 100 is ended or there are not any empty parking spaces.

If a parking lot reservation cancellation request is received from the operator terminal 300, the parking lot reservation server 200 may receive one or more parking lot information which has been previously stored in the database or one or more parking lot information from the third party server and may provide to the subscriber terminal 100 which is a reservation cancellation target.

The parking lot reservation server 200 may select a parking lot which is located near the parking lot which has been reserved by the subscriber terminal 100 and provide a parking lot information thereon. For this reason, it is possible to prevent the parking lot reservations from concentrating at one parking lot, by means of which enough parking spaces can be obtained, thus providing the optimum parking services to the subscribers.

For this operation, the parking lot reservation server 200 may receive a predetermined information including a destination information and a meeting information of the subscriber terminal 100 from the schedule management server (not illustrated) which operates in cooperation with the subscriber terminal 100 and subsequently may provide the received information to the operator terminal 300 of the reserved parking lot.

The parking lot reservation server 200 may carry out a reservation procedure by receiving a parking lot information of the parking lot selected by the subscriber terminal 100 among at least one parking lot provided in the step S12 and a parking lot reservation request of the subscriber terminal 100 (S13). The parking lot reservation request may include a parking lot reservation information. The parking lot reservation information may include a subscriber name, a contact information, a parking lot name, a parking lot visit time, and a parking lot use hour.

If the reservation procedure is carried out in the step S13, and then the parking lot reservation is completed, the parking lot reservation server 200 may obtain a position information of the subscriber terminal 100 before a previously set time from the reserved time, and then provide to the operator terminal 300 of the reserved parking lot (S14). The parking lot reservation server 200 may obtain a position information of the subscriber terminal 100 in such a way to use any of a GPS information of the subscriber terminal 100, an identification information of a network equipment which may be searched from the subscriber terminal 100, and a mobile IP (Internet Protocol) address information of the subscriber terminal 100.

Moreover, the parking reservation server 200 may transmit a push message to obtain a position information of the subscriber terminal 100 if a time passes before as much as the previously set time from the reservation-made time. If the subscriber terminal 100 receives the push message, the parking lot reservation server 200 may obtain a position information calculated when the push message has been received, and then may provide the obtained information to the operator terminal 300.

For example, the subscriber terminal 100 may include an application programmed to transmit the position information to the operator terminal 300 if the push message has been received from the parking lot reservation server 200, and if the application installed at the subscriber terminal 100 receives the push message, the position information of the subscriber terminal 100 can be transmitted to the operator terminal 300.

The aforementioned push message may be repeatedly transmitted a couple of times to the subscriber terminal 100 at a previously set time interval before the reserved time.

If the position information of the subscriber terminal 100 is obtained in the step S14, the parking lot reservation server 200 may calculate an estimate lead time based on the position information of the subscriber terminal 100 and the position information of the reserved parking lot (S15).

The parking lot reservation server 200 may calculate an estimate time of parking lot arrival of the subscriber terminal 100 based on the estimate lead time and may provide to the operator terminal 300 of the selected parking lot.

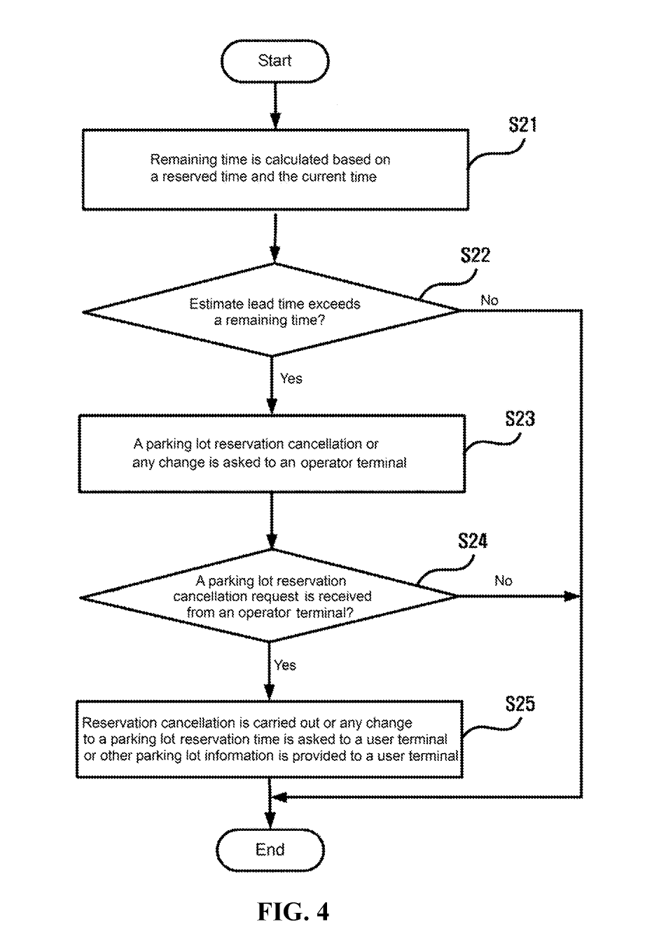

FIG. 4 is a flow chart for describing a state wherein an estimate time of arrival calculated based on a position information of a subscriber terminal and a position information of a reserved parking lot exceeds a remaining time which is calculated based on a parking space reservation time and the current time.

The parking lot reservation server 200 may calculate a remaining time based on the parking lot reservation time and the current time (S21).

If the estimate lead time calculated in the step S15 exceeds the remaining time calculated in the step S21 (S22), the parking lot reservation server 200 may ask the operator terminal 300 for a parking lot reservation cancellation state (S23). Subsequently, the parking lot reservation server 200 may provide to the subscriber terminal 100, which is a parking lot reservation cancellation target, a parking lot information of at least one or more nearby parking lots near the reserved parking lot if the parking lot reservation cancellation request is received (S24) from the operator terminal 300. Moreover, the parking lot reservation server 200 may carry out a parking lot reservation cancellation in response to the reservation cancellation request of the operator terminal 300 or may ask the subscriber terminal 100 for any change to the reserved time (S25).

If the estimate lead time calculated in the step S15 exceeds the remaining time calculated in the step S21 (S22), the parking lot reservation server 200 may ask the subscriber terminal 100 for a parking lot reservation cancellation state.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

The scope of the present invention may be defined by the claims below rather than the detailed descriptions, and it should be interpreted that the meanings and scopes of claims and all changed or modified forms deriving from their equivalents belong to the scope of the present invention.

1. A parking lot reservation method, comprising:
a step wherein a parking lot reservation is carried out by a parking lot reservation server, and a parking lot information request is received from a subscriber terminal;
a step wherein at least one parking lot information is provided to the subscriber terminal in response to the parking lot information request;
a step wherein a reservation procedure is carried out by receiving a parking lot information of a parking lot which is selected by the subscriber terminal from at least one parking lots and a parking lot reservation request of the subscriber terminal; and
a step wherein when a parking lot reservation is completed, a position information of the subscriber terminal is obtained before a previously set time from a reservation-made time, and is provided to an operator terminal of the reserved parking lot.

2. The method of claim 1, wherein the parking lot reservation method further comprise a step wherein an estimate lead time is calculated based on a position information of the subscriber terminal and a position information of the reserved parking lot, and an estimate time of parking lot arrival of the subscriber terminal is calculated based on the estimate lead time, and is provided to the operator terminal of the selected parking lot.

3. The method of claim 1, wherein the step for providing to the operator terminal includes a step wherein a push message is transmitted to obtain a position information of the subscriber terminal if a time passes before as much as the previously set time from the reservation-made time.

4. The method of claim 3, wherein the step for providing to the operator terminal includes a step wherein the push message is repeatedly transmitted a couple of times to the subscriber terminal at a previously set time interval before the reserved time.

5. The method of claim 1, wherein the parking lot reservation method further comprises:
a step wherein an estimate lead time is calculated based on a position information of the subscriber terminal and a position information of the reserved parking lot; and
a step wherein a remaining time is calculated based on the reserved time and the current time, and if the estimate lead time exceeds the remaining time, a confirmation message to ask for a parking lot reservation cancellation state is transmitted to the subscriber terminal.

6. The method of claim 5, wherein the step for transmitting a confirmation message includes a step wherein if the estimate lead time exceeds the remaining time, a confirmation message to ask for a parking lot reservation cancellation state is transmitted to the operator terminal of the reserved parking lot.

7. The method of claim 6, wherein the step for providing the parking lot information includes a step wherein if a parking lot reservation cancellation request is received from the operator terminal, a parking lot information on at least one nearby parking lots located near the reserved parking lot is provided to the subscriber terminal which is a parking lot reservation cancellation target.

8. The method of claim 1, wherein the step for providing the parking lot information includes a step wherein a predetermined information including a destination information and a meeting time information of the subscriber terminal is received from the subscriber terminal or a schedule management server which operates in cooperation with the subscriber terminal, and the received predetermined information is provided to the operator terminal of the reserved parking lot.

9. The method of claim 7, wherein the parking lot reservation method further includes a step wherein if a parking lot reservation cancellation request is received from the operator terminal in the step for providing the parking lot information, a parking lot reservation cancellation is carried out in response to the reservation cancellation request or any change to the reserved parking lot reservation time is asked to the subscriber terminal.

10. A parking lot reservation system, comprising:
a request receiving unit which is configured to receive a parking lot information request from a subscriber terminal in a parking lot reservation server;
a parking lot information providing unit which is configured to provide at least one parking lot information to the subscriber terminal in response to the parking lot information request;
a reservation processing unit which is configured to carry out a reservation procedure by receiving a parking lot information of the parking lot selected by the subscriber terminal among at least one parking lots, and a parking lot reservation request of the subscriber terminal; and
a position information providing unit which is configured to obtain a position information of the subscriber terminal before a previously set time from the reserved time if the parking lot reservation is completed, and provide the obtained information to the operator terminal of the reserved parking lot.

11. The system of claim 10, wherein the parking lot reservation system further includes a time calculation unit which is employed to calculate an estimate lead time based on a position information of the subscriber terminal and a position information of the reserved parking lot, and calculate an estimate time of parking lot arrival of the subscriber terminal based on the estimate lead time, and provide the calculated time to the operator terminal of the selected parking lot.

12. The system of claim 10, wherein the position information providing unit is configured to transmit a push message to obtain a position information of the subscriber terminal if a time passes before as much as the previously set time from the reservation-made time.

13. The system of claim 12, wherein the push message is configured to be repeatedly transmitted a couple of times to the subscriber terminal based on a previously set time interval before the reserved time.

14. The system of claim 10, wherein the parking lot reservation system further comprises:
a time calculation unit which is able to calculate an estimate lead time based on a position information of the subscriber terminal and a position information of the reserved parking lot; and
a message transmission unit which is employed to calculate a remaining time based on the reserved time and the current time, and if the estimate lead time exceeds the remaining time, it transmits a confirmation message to ask a parking lot reservation cancellation state to the subscriber terminal.

15. The system of claim 14, wherein if the estimate lead time exceeds the remaining time, the message transmission unit transmits a confirmation message to ask a parking lot reservation cancellation state to the operator terminal of the reserved parking lot.

16. The system of claim 10, wherein if a parking lot reservation cancellation request is received from the operator terminal, the parking lot information providing unit provides a parking lot information of at least one or more nearby parking lots located near the reserved parking lot to the subscriber terminal which is a parking lot reservation cancellation target.

17. The system of claim 1, wherein the parking lot information providing unit is configured to receive a predetermined information including a destination information and a meeting time information of the subscriber terminal from a schedule management server which operates in cooperation with the subscriber terminal, and provide the received information to the operator terminal of the reserved parking lot.

18. The system of claim 16, wherein the parking lot reservation system further comprises:
a reservation change unit which is configured to carry out a parking lot reservation cancellation in response to a reservation cancellation request if the parking lot information providing unit receives the parking lot reservation cancellation request from the operator terminal or ask the subscriber terminal for any change to the reserved parking lot reservation time.

19. A parking lot reservation method, comprising:
a step wherein a parking lot reservation is carried out by a parking lot operator terminal which communicate with a parking lot reservation server via a network, and a position information of a subscriber terminal which has reserved a parking space corresponding to the operator terminal is received from the parking lot reservation server if a time passes before as much as the previously set time from the reservation-made time;
a step wherein an estimate lead time is calculated based on the received position information of the subscriber terminal and a position information of the parking lot corresponding to the operator terminal; and
a step wherein the calculated estimate lead time or an estimate time of parking lot arrival of the subscriber terminal calculated based on the estimate lead time are displayed.

20. (canceled)
